(19) United States
(12) Patent Application Publication
(10) Pub. No.: US 2020/0386198 A1
(43) Pub. Date: Dec. 10, 2020

(54) FUEL FILTER DEVICE FOR AN INTERNAL COMBUSTION ENGINE

(71) Applicant: Mahle International GmbH, Stuttgart (DE)

(72) Inventors: Martin Hein, Stuttgart (DE); Peter Koppi, Sankt Margarethen (AT); Maria Kraut, St. Michael (AT); Markus Preissinger, Leonberg (DE); Julia Santer, Voelkermarkt (AT)

(21) Appl. No.: 16/758,852

(22) PCT Filed: Oct. 1, 2017
(86) PCT No.: PCT/EP2018/076659

§ 371 Date: Apr. 23, 2020

(30) Foreign Application Priority Data
Oct. 24, 2017 (DE) 10 2017 218 995.9

(51) Int. Cl. F02M 37/24; B01D 36/00; B01D 61/28; B01D 63/02; B01D 71/68

(52) U.S. Cl. CPC F02M 37/24; B01D 36/003; B01D 2315/10; B01D 63/02; B01D 71/68; B01D 61/28

(57) ABSTRACT

A fuel filter device for an internal combustion engine may include a water separator through which a fuel is flowable. To separate water contained in the fuel, the water separator may include a porous and hydrophilic membrane, which may include or be made of polymeric hollow fibers and which may be formed for cross-flow filtration of the fuel. A material of the hollow fibers may be hydrophilized via polyvinylpyrrolidone (PVP). The fuel filter device or the water separator may have a hydrophobic membrane for filtering residual fuel from the water separated via the hydrophilic membrane.

### CROSS-REFERENCE TO RELATED APPLICATIONS

This application claims priority to International Patent Application No. PCT/EP2018/076659, filed on Oct. 1, 2018, and German Patent Application No. DE 10 2017 218 995.9, filed on Oct. 24, 2017, the contents of both of which are hereby incorporated by reference in their entirety.

### TECHNICAL FIELD

The present invention relates to a fuel filter device for an internal combustion engine as well as an internal combustion engine comprising a fuel filter device of this type.

### BACKGROUND

In modern fuel supply systems, water separators are usually used in the corresponding fuel filter device, in order to lower a water portion contained in the fuel as much as possible. If the water contained in the fuel is not segregated and separated, unwanted corrosion, abrasion, material embrittlement as well as cavitation can result in the following aggregates. An increased water portion in the fuel supply system likewise leads to a growth promotion of microorganisms, which effect a sliming of the fuel filter device and which can cause an increased corrosion on the filter housing.

So-called coalescers, which coalesce the smallest water portions into larger drops of water and separate them from the fuel-water emulsion on the basis of gravity, are thereby typically used as water separators. If necessary for the water separation, a so-called final separator consisting of a hydrophobic tissue can furthermore filter out the drops of water contained in the fuel-water emulsion. The water separated in this way is then collected in separate water collection chambers, from which it is drained periodically or no later than when replacing a filter element.

A filter element consisting of a pleat star and two plastic end plates is usually used in the case of the diesel fuel filtration. To achieve high separation performance, the setup of the filter element is sometimes very complex. A three-stage filter element, consisting of a particle filter, a hydrophilic coalescer, and a hydrophobic final separator, is thus usually used for the diesel filtration. Each individual stage can thereby consist of several filter layers. The filter element has only a limited service life and has to be replaced at regular intervals, in order to achieve the required separation performance.

EP 2 331 229 B1 discloses a three-stage fuel filter of this type.

A complex water discharge system, consisting of a water collection chamber, several valves connected in series, and an activated carbon filter connected downstream, is furthermore necessary in the case of diesel fuel systems. This setup results in a large space requirement. In addition, the valves have to be controlled by means of a suitable sensor system, which is likewise installed in the water collection chamber.

It turns out to be disadvantageous in the case of all mentioned systems that they are constructed in a complex manner and are thus expensive.

### SUMMARY

The present invention thus deals with the problem of creating an improved embodiment for a fuel filter device, in particular for the filtration of diesel fuel, by means of which good separation values for the water contained in the fuel can be achieved, and which is nonetheless constructed in a technically simple manner, so that, compared to conventional fuel filter devices, it can be produced particularly cost-efficiently.

This problem is solved according to the invention by means of the subject matters of the independent patent claims. Advantageous embodiments are subject matter of the dependent patent claims.

It is thus the basic idea of the invention to form the water separator of a fuel filter device by means of a porous and hydrophilic membrane, which has polymeric hollow fibers. A membrane designed in this way combines the coalescing properties of a hydrophilic coalescer with the final separation for the water separation. The uncleaned fuel, which thus contains water, is thereby guided through the porous, polymeric and hydrophilic membrane, which forms the water separator. Depending on demand, the membrane can thereby consist of different polymers. Polyethersulfone (PE), which was hydrophilized with the pore-forming agent polyvinylpyrrolidone (PVP), is preferred material for the membrane.

The water separator of the fuel filter device introduced here comprising the hydrophilic membrane, which is essential for the invention, is operated in the so-called crossflow mode—also known to the person of skill in the art as “cross-flow filtration”. Due to this mode of operation and the highly hydrophilic character of the membrane, two effects are utilized: Due to the interaction of the hydrophilic membrane surface with the polar water molecules, the membrane acts as coalescer, which leads to the enlargement of the drop size of the water contained in the fuel and thus also to the decrease of the flow rate. This supports a particularly effective separation of the drops of water from the fuel. In addition, the drops of water pass through the hydrophilic membrane hollow fibers as permeate, whereas fuel portions with hydrophobic polarity leave the hydrophilic membrane as concentrate flow (retentate).

A further advantage of the use according to the invention of highly hydrophilic hollow fibers is that, due to the corresponding determination of pore size and pore size distribution, preferably as part of the production of the hollow fibers, the separation performance of the membrane can be set in an accordingly optimized manner, as well as the level of the hydrophily, which is significantly determined by the pore-forming agent PVP. The ratio of permeate flow to concentrate flow (retentate) can likewise be optimized for the crossflow operation in such a way that the separated water in the permeate contains significantly lower portions of residual fuel than in the case of conventional fuel filter devices.

The water separated by means of the membrane can be additionally cleaned in the fuel filter device, so that it can subsequently be released directly into the environment. Depending on the demands on the purity of the fuel, the membrane can also be combined and interconnected with further systems, such as, e.g., a further membrane, a particle filter connected upstream or an additional hydrophobic final separator. A so-called police filter, which interrupts the fluid connection to the environment, if fuel portions, which may be in the water after all, were detected, can additionally be used as safety system for the separated water downstream from the hydrophilic membrane.

In the end, the provision of a hydrophobic final separator is not mandatorily required in the case of the fuel filter device introduced here, which results in significant cost advantages in the production of the fuel filter device. The need for installation space is also significantly reduced as compared to conventional fuel filter devices.

A fuel filter device according to the invention for an internal combustion engine, in particular for a diesel engine, comprises a water separator, through which fuel, in particular diesel fuel, can flow. To separate water contained in the fuel, the water separator comprises a porous and hydrophilic membrane, which comprises polymeric hollow fibers and which is formed for the cross-flow filtration of the fuel.

According to a preferred embodiment, the material for producing the hollow fibers consists of relatively hydrophobic polyethersulfone (PES). Particularly preferably for the hydrophilization of the base polymer polyethersulfone, the pore-forming agent is polyvinylpyrrolidone (PVP). By means of the mentioned two polymers, the desired hydrophilic properties of the membrane can be realized particularly easily and thus cost-efficiently by means of a suitable production process.

Advantageously, a pore size of the hydrophilic membrane is between 0.01 μm and 5 preferably between 0.1 μm and 1 μm. It goes without saying that other values are also possible in variations, so that the degree of separation, which can be achieved by means of the hydrophilic membrane, can also be varied by means of corresponding setting of the pore size.

To ensure that the water, which is not separated completely from the fuel by means of the hydrophilic membrane, does not reach into the internal combustion engine connected downstream from the water separator, the water separator can be equipped with an additional final separator. Said final separator thus serves to separate residual water from the fuel, which is cleaned by means of the hydrophilic membrane, and is arranged here downstream from the hydrophilic membrane.

According to an advantageous further development, the fuel filter device comprises a filter housing, which surrounds a housing interior and in which the water separator comprising the hydrophilic membrane is arranged. In the case of this further development, a fuel inlet for introducing the unfiltered fuel, as well as a fuel outlet for discharging the filtered fuel, are provided in the filter housing in the case of this further development. A water outlet for discharging the separated water is furthermore also provided in the filter housing. To realize the cross-flow filtration according to the invention, it is recommended to arrange the fuel outlet in such a way that it is located opposite the fuel inlet. In the case of this further development, the water outlet is arranged transversely to the fuel inlet as well as transversely to the fuel outlet.

According to another advantageous further development, the fuel filter device can have a hydrophobic, thus water-repellent membrane connected downstream, in addition to the hydrophilic membrane according to the invention. Said hydrophobic membrane serves to separate residual fuel from the water, which is separated as permeate by means of the hydrophilic membrane. The separated water can thus be released directly into the environment, without the environment being contaminated by the residual fuel contained in the water.

It turns out to be particularly advantageous, when the water, which is separated by means of the hydrophilic membrane, is also filtered by using the hydrophobic membrane by means of cross-flow filtration. The hydrophobic membrane can also be arranged in a filter housing here, as has already been proposed and described above for the hydrophilic membrane, which is essential for the invention. A water inlet as well as a water outlet located opposite the water inlet are thus provided in a filter housing of this type, and a fuel outlet for the residual fuel separated from the water is arranged transversely to water inlet and water outlet. The same advantages are thus achieved as in the case of the cross-flow filtration of the fuel with the help of the hydrophilic membrane.

The hydrophobic membrane can advantageously be formed as screen or as knitted wire mesh. A membrane formed in this way has a high service life and can additionally be obtained cost-efficiently.

In the case of a preferred embodiment, the water separator comprises an electrical coalescer comprising two electrodes, between which the hydrophilic membrane is arranged. This embodiment has independent invention character. The electrical field generated by the electrodes thereby does not lead to an enlargement of drops of water, as in the case of conventional electrical coalescers, which form the water contained in the fuel, but polarize the drops of water and have the effect that the drops of water are transported to the polar surface of the hydrophilic membrane. An enlargement of the drops of water, which may nonetheless take place to a small extent, due to the electrical field, does not have a negative impact on the separation performance, but influences it positively. The stronger the electrostatic interaction between the electrical field created by the electrical coalescer and the polar drops of water, the higher the force effect is also on the drops, and the transport process towards the polar hydrophilic membrane surface is accelerated, whereby the separation performance of water from the fuel is improved with the help of the hydrophilic membrane.

According to an advantageous further development, a first one of the two electrodes is formed as jacket electrode, which envelopes the hydrophilic membrane in a jacket-like manner. In addition, a second one of the two electrodes in the case of this further development is formed as central electrode, which is arranged in the membrane in a centered manner. Both electrodes, preferably the jacket electrode and the central electrode, can advantageously be formed as coaxial cylinder. A coaxial electrode arrangement offers the advantage that an inhomogeneous electrical field, which has a higher field line density in the area around the central electrode, is created by applying a voltage.

The electrical coalescer 30 can have a direct current input voltage of 0-5.000 V, a pulsed direct current voltage from 0 to 5.000 V or an alternating current input voltage from 0 to 40.000 V. The direct current voltage preferably has a frequency from 0 to 10.000 Hz and/or the alternating current input voltage has a frequency from 0 to 10.000 Hz. Depending on the desired degree of separation and depending on the available voltage supply, it can thus be selected freely, with which type of electrical voltage the water separator according to the invention, i.e. the electrical coalescer, is operated. Pulsed direct current or alternating current, respectively, is thus in particular suitable for the water separation in the case of the tendency of drop chain formation of the water droplets in the case of large quantities of water.

The invention further relates to a motor vehicle comprising an internal combustion engine, in particular comprising a diesel engine. The motor vehicle furthermore comprises a fuel reservoir, preferably a fuel tank, which is connected to the internal combustion engine by means of a fuel line to supply the internal combustion engine with fuel, in particular with diesel fuel. The above-introduced fuel filter device is arranged in the fuel line. The above-described advantages of the fuel filter device can thus also be transferred to the motor vehicle according to the invention.

According to a preferred embodiment, the motor vehicle comprises a fuel return line, by means of which the residual fuel, which is discharged through the hydrophobic membrane, can be returned into the fuel reservoir.

This fuel is thus available for use in the internal combustion engine.

According to an advantageous further development, the fuel filter device or the water separator thereof, respectively, comprises a police filter. This police filter is formed in such a way that it interrupts a fluid connection of the water separator to the external environment of the fuel filter device, when it is detected that a portion of residual fuel contained in the water exceeds a predetermined threshold value when the water separated from the water separator flows through the police filter. By suitably determining the threshold value, it can be ensured that the residual fuel contained in the separated water does not reach into the surrounding area of the fuel filter device or into the environment, respectively.

Further important features and advantages of the invention follow from the subclaims, from the drawing, and from the corresponding figure description on the basis of the drawings.

It goes without saying that the above-mentioned features and the features, which will be described below, cannot only be used in the respective specified combination, but also in other combinations or alone, without leaving the scope of the present invention.

### BRIEF DESCRIPTION OF THE DRAWINGS

Preferred exemplary embodiments of the invention are illustrated in the drawings and will be described in more detail in the following description, in which

FIG. 1 shows, in schematic, circuit diagram-like manner, the setup of a motor vehicle according to the invention comprising the fuel filter device according to the invention.

FIG. 2 shows the setup of the water separator of the fuel filter device.

### DETAILED DESCRIPTION

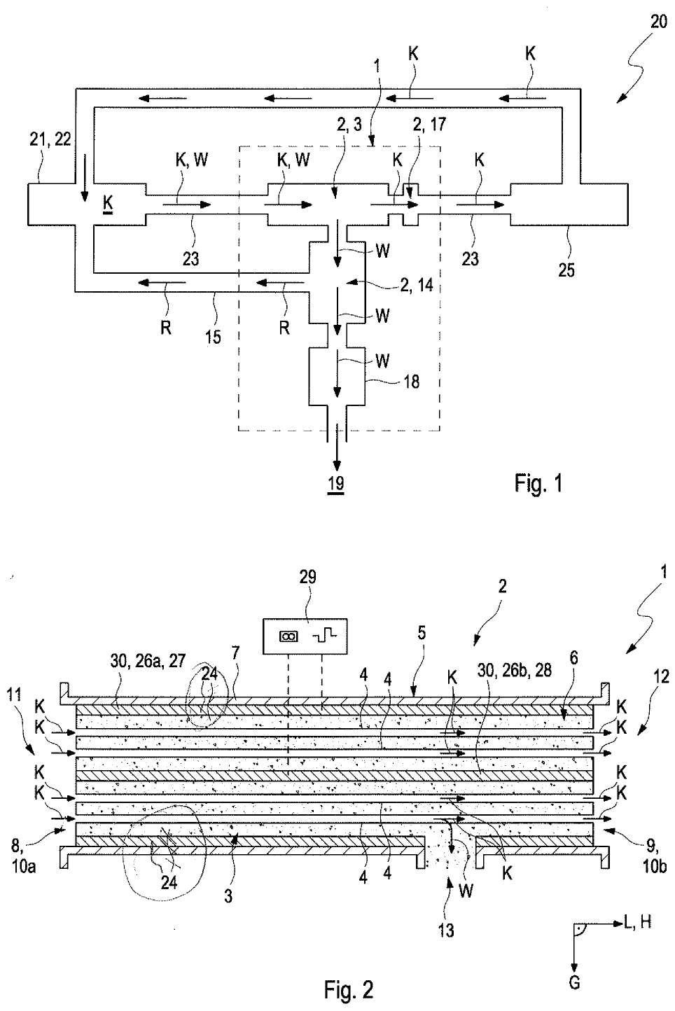

FIG. 1 shows, in schematic circuit diagram-like illustration, the components of a motor vehicle 20 according to the invention, which interact with the fuel filter device 1 according to the invention. According to FIG. 1, the motor vehicle 20 comprises an internal combustion engine 25, which can be realized as diesel engine, as well as a fuel reservoir 21, which s formed as fuel tank 22. The fuel reservoir 21 serves to supply the internal combustion engine with fuel K, in the case of the diesel engine thus with diesel fuel. For this purpose, the fuel reservoir 21 is connected to the internal combustion engine 25 by means of a fuel line 23. A fuel filter device 1 according to the invention is arranged in the fuel line 23.

The fuel filter device 1 is shown in FIG. 2 in separate illustration in a highly simplified longitudinal section. According to this, the fuel filter device 1 comprises a water separator 2, through which the fuel K or the diesel fuel, respectively, can flow. As can be seen in FIG. 2, the water separator 2 comprises a porous and hydrophilic membrane 3 for separating water W contained in the fuel K. The membrane 3 is operated in the mode “cross-flow filtration” and comprises a plurality of polymeric hollow fibers 4.

For the sake of clarity, only four such hollow fibers 4 are illustrated in a highly enlarged manner in the simplified illustration of FIG. 2. It is clear that a significantly larger number of hollow fibers 4 can be provided.

According to FIG. 2, the fuel filter device 1 comprises a filter housing 5, which surrounds a housing interior 6. The water separator 2 comprising the hydrophilic membrane 3 is arranged in the housing interior 6. The filter housing 5 is preferably formed in an elongate manner and extends along a longitudinal direction L in this case. The longitudinal direction L forms a main direction of extension H of the hollow fibers 4, i.e. the hollow fibers 4, which are not formed completely straight, nevertheless elongated hollow fibers 4, extend essentially along the longitudinal direction L of the filter housing 5. Along said longitudinal direction L, the housing interior 6 is limited by a circumferential wall 7 of the filter housing 5. An open first front side 10a of the filter housing 5 forms a raw-side fuel inlet 8 for introducing the unfiltered fuel into the housing interior 6. An open second front side 10b located opposite the first font side 10a forms an edge-side fuel outlet 9 for discharging the filtered fuel K. To seal the raw side 11 of the water separator 2 against the clean side 12 thereof, the hollow fibers 4 are fixed by means of a suitable plastic compound 24.

The fuel K to be filtered reaches out of the fuel reservoir 21 or the fuel tank 22, respectively, via the fuel line 23 to the fuel inlet 8 and is introduced via the latter into the housing interior 6. After the flow-through of the membrane 3 in the housing interior 6, the fuel K, which is discharged from the housing interior 6 via the fuel outlet 9, reaches via the fuel line 23 into the internal combustion engine 25.

A fuel return line 16 between the internal combustion engine 25 and the fuel reservoir 21 or the fuel tank 22, respectively, provides for the return of fuel K from the internal combustion engine 25 into the fuel reservoir 21 or into the fuel tank 22, respectively.

According to FIG. 2, a water outlet 13, via which the water W separated from the water separator 2 can be discharged from the filter housing 5, is also arranged in the filter housing 5 of the fuel filter device 1. According to FIG. 2, the fuel outlet 9 is located opposite the fuel inlet 8 along the longitudinal direction L, whereas the water outlet 13 provided in the circumferential wall 7 is arranged transversely to the fuel inlet 8 and to the fuel outlet 9. In the case of a suitable arrangement of the water separator 2 in such a way that the longitudinal direction L extends orthogonally to the direction of gravity G, the gravity acting on the separated water W can thus be used to separate water W from the fuel K particularly effectively and to subsequently discharge it from the water separator 2.

Polyethersulfone lends itself as base polymer for producing the polymeric hollow fibers 4 of the hydrophilic membrane 3. To provide it with the desired hydrophilic properties, the polyethersulfone is hydrophilized by means of polyvinylpyrrolidone. A pore size of the hollow fibers of the porous hydrophilic membrane 3 can be between 0.01 μm and 5 μm, preferably between 0.1 μm and 1 μm.

The water separator 2 can optionally comprise an additional final separator 17, which is only suggested in a roughly schematic manner in the figures, for separating residual water from the fuel, which is cleaned by means of the hydrophilic membrane 3.

The fuel filter device 1 can additionally be equipped with a further membrane 14, which, in contrast to the hydrophilic membrane 3, however, is formed to be hydrophobic, thus water-repellent. The hydrophobic membrane 14 serves the purpose of filtering residual fuel K, which may be present, out of the water W, which is separated by means of the hydrophilic membrane 3. Analogously to the hydrophilic membrane 3, the hydrophobic membrane 14 can also be formed for the cross-flow filtration of the water separated by means of the hydrophilic membrane. The hydrophobic membrane 14 can be formed as screen or as knitted wire mesh. For this purpose, the hydrophobic membrane 14, analogously to the hydrophilic membrane 3, can be integrated into a filter housing, as it is illustrated in FIG. 2. It is also conceivable, however, to integrate the hydrophilic membrane 3 as well as the hydrophobic membrane 14 into a single, common filter housing (not shown). With regard to the concrete design of the fuel filter device 1, in particular relating to the arrangement of the two membranes 3, 14 in a filter housing, different design options result for the pertinent person of skill in the art, from which he can select, depending on the application.

As can be seen in FIG. 2, the water separator 2 can also have an electrical coalescer 30 comprising two electrodes 26a, 26b, between which the hydrophilic membrane 3 is arranged. A first one of the two electrodes 26a is thereby formed as jacket electrode 27, which envelopes the hydrophilic membrane 3 in a jacket-like manner. A second one of the two electrodes 26b is formed as central electrode 28, which is arranged in the hydrophilic membrane 3 in a centered manner. Both electrodes 26a 26b, thus the jacket electrode 27 and the central electrode 38, can advantageously be formed as coaxial cylinder. A coaxial electrode arrangement of the two electrodes 26a, 26b offers the advantage that an inhomogeneous electrical field, which has a higher field line density in the area around the central electrode, is created by applying a voltage.

The electrical coalescer 30 can advantageously have a direct current input voltage of 0V to 5.000 V, a pulsed direct current voltage of 0 V to 5.000 V or an alternating current input voltage from 0 V to 40.000 V. The direct current voltage preferably has a frequency from 0 to 10.000 Hz and/or the alternating current input voltage has a frequency from 0 to 10.000 Hz. The two electrodes 26a, 26b can be connected to a suitable electrical voltage supply 29 for this purpose. Depending on the desired degree of separation and depending on the available voltage supply, it can thus be selected freely, with which type of electrical voltage the electrical coalescer 30 is operated.

Referring once again to FIG. 1, it can be seen that the motor vehicle 20 can be equipped with a fuel return line 15, which allows returning the residual fuel R separated from the water by means of the hydrophobic membrane 14 into the fuel reservoir 21 or the fuel tank 22, respectively.

The fuel filter device 1 or the water separator 2, respectively, can optionally comprise a police filter 18. This police filter 18 is preferably formed in such a way that it interrupts a fluid connection of the water separator 2 to the outer external environment 19 of the fuel filter device 1, if it is detected that the portion of residual fuel R still contained in the water W exceeds a predetermined threshold value, when the water W separated by the water separator 2 flows through the police filter 18.

1.-16. (canceled)

17. A fuel filter device for an internal combustion engine, comprising:
a water separator through which a fuel is flowable;
wherein, to separate water contained in the fuel, the water separator comprises a porous and hydrophilic membrane, which comprises or is made of polymeric hollow fibers and which is formed for cross-flow filtration of the fuel;
wherein a material of the hollow fibers is hydrophilized via polyvinylpyrrolidone (PVP); and
wherein the fuel filter device or the water separator has a hydrophobic membrane for filtering residual fuel from the water separated via the hydrophilic membrane.

18. The fuel filter device according to claim 17, wherein the material of the hollow fibers comprises polyethersulfone.

19. The fuel filter device according to claim 17, wherein a pore size of the hydrophilic membrane is between 0.01 μm and 5 μm.

20. The fuel filter device according to claim 17, wherein the water separator comprises a final separator for separating residual water from the fuel cleaned via the hydrophilic membrane.

21. The fuel filter device according to claim 17, further comprising a filter housing, which surrounds a housing interior and in which the hydrophilic membrane is arranged, wherein a fuel inlet for introducing the unfiltered fuel, a fuel outlet for discharging the filtered fuel, and a water outlet for discharging the separated water are provided in the filter housing, wherein the fuel outlet is located opposite the fuel inlet, and the water outlet is arranged transversely to the fuel inlet or to the fuel outlet, respectively.

22. The fuel filter device according to claim 17, wherein the hydrophobic membrane is formed or set up for the cross-flow filtration of the water separated via the hydrophilic membrane.

23. The fuel filter device according to claim 17, wherein the hydrophobic membrane is formed as screen or as knitted wire mesh.

24. The fuel filter device according to claim 17, wherein the water separator has an electrical coalescer including two electrodes between which the hydrophilic membrane is arranged.

25. The fuel filter device according to claim 24, wherein a first one of the two electrodes is formed as a jacket electrode, which envelopes the hydrophilic membrane in a jacket-like manner, and that a second one of the two electrodes is formed as a central electrode, which is arranged in the membrane in a centered manner.

26. The fuel filter device according to claim 24, wherein the two electrodes are formed as coaxial cylinders.

27. The fuel filter device according to claim 24, wherein the electrical coalescer including the the electrodes has a direct current input voltage of 0-5.000 V, a pulsed direct current voltage of 0-5.000 V, or an alternating current input voltage of 0-40.000 V, wherein at least one of the direct current voltage has a frequency of 0-10.000 Hz and the alternating current input voltage has a frequency of 0-10.000 Hz.

28. A motor vehicle comprising:
an internal combustion engine, in particular a diesel engine;
a fuel reservoir, which is connected to the internal combustion engine via a fuel line to supply the internal combustion engine with fuel; and
a fuel filter device arranged in the fuel line, the fuel filter device including a water separator through which a fuel is flowable;
wherein, to separate water contained in the fuel, the water separator comprises a porous and hydrophilic membrane, which comprises or is made of polymeric hollow fibers and which is formed for cross-flow filtration of the fuel;
wherein a material of the hollow fibers is hydrophilized via polyvinylpyrrolidone (PVP); and
wherein the fuel filter device or the water separator has a hydrophobic membrane for filtering residual fuel from the water separated via the hydrophilic membrane.

29. The motor vehicle according to claim 28, further comprising a fuel return line, via which the residual fuel, which is discharged through the hydrophobic membrane, is returnable into the fuel reservoir.

30. The motor vehicle according to claim 28, wherein the fuel filter device or the water separator comprises a police filter, which is formed in such a way that it interrupts a fluid connection of the water separator to the external environment of the fuel filter device, when it is detected that a portion of residual fuel contained in the water exceeds a predetermined threshold value when the water separated from the water separator flows through the police filter.

31. The motor vehicle according to claim 28, wherein the internal combustion engine is a diesel engine and the fuel is diesel fuel.

32. The motor vehicle according to claim 17, wherein the material of the hollow fibers comprises polyethersulfone.

33. The motor vehicle according to claim 17, wherein a pore size of the hydrophilic membrane is between 0.01 μm and 5 μm.

34. The fuel filter device according to claim 19, wherein the pore size of the hydrophilic membrane is between 0.1 μm and 1 μm.

35. The fuel filter device according to claim 25, wherein the jacket electrode and the central electrode are formed as coaxial cylinders.

36. A fuel filter device for an internal combustion engine, comprising:
a water separator through which a fuel is flowable;
wherein, to separate water contained in the fuel, the water separator comprises a porous and hydrophilic membrane, which comprises or is made of polymeric hollow fibers and which is formed for cross-flow filtration of the fuel;
wherein a material of the hollow fibers is hydrophilized via polyvinylpyrrolidone (PVP);
wherein the fuel filter device or the water separator has a hydrophobic membrane for filtering residual fuel from the water separated via the hydrophilic membrane;
wherein the material of the hollow fibers comprises polyethersulfone; and
wherein the water separator has an electrical coalescer including two electrodes between which the hydrophilic membrane is arranged.
